(19) United States
(12) Patent Application Publication
(10) Pub. No.: US 2007/0215089 A1
(43) Pub. Date: Sep. 20, 2007

(54) Internal Combustion Engine Starte Comprising a Cylinder Head and Speed Reducer Centering Means On This Case

(76) Inventors: Laurent-Yves Grand, Lyon (FR); Thierry Paltrie, Lyon (FR)

Correspondence Address: BERENATO, WHITE & STAVISH, 6550 rOCK Spring Drive, Ste., 240, Bethesda, MD, 20817, US

(21) Appl. No.: 10/576,793

(22) PCT Filed: Nov. 29, 2004
(86) PCT No.: PCT/FR04/03060

§ 371 Date: Nov. 6, 2006

(30) Foreign Application Priority Data
Nov. 28, 2003 (FR) 0314010
Nov. 28, 2003 (FR) 0314011
Nov. 28, 2003 (FR) 0314009

(51) Int. Cl. F02N 11/00

(52) U.S. Cl. 123/179.25

(57) ABSTRACT

The invention relates to a starter comprising an electric engine (11) which is connected to a starter drive assembly (30) with a planetary gear speed reducer (45) inserted therebetween. According to the invention, the reducer is housed inside a fixed ring gear (46) which comprises a centering (73) having a first support face (70) which is located in the same plane as the connection interface between the support (16) and the cylinder head (15). The invention is suitable for a motor vehicle starter.

### TECHNICAL FIELD OF THE INVENTION

The invention relates to a starter for an internal combustion engine, in particular an internal combustion engine for a motor vehicle, comprising an electric motor having a cylindrical housing supporting the stator, and a rotor coupled to an output shaft for rotationally driving a starter head with the interposing of an epicyclic gearbox, the said gearbox comprising:
a ring gear having an internally toothed cylindrical annular skirt, and a radial flange provided with a hole for the coaxial passage of the output shaft,
and means for the axial centering of the said ring gear in the starter support.

### PRIOR ART

The document FR-A-2767157 describes a starter for the internal combustion engine of a motor vehicle of the type mentioned, in which the axial fixing of the fixed ring gear of the gearbox on the starter support is achieved by contact of one wall of the ring gear on a rim of the support. The housing of the field winding bears against the end of the support, which is axially separated from the rim of the support by a predetermined distance. The centering of the support and housing takes place over the entire length of the annular skirt of the ring gear.

Such an arrangement requires precise machining of the support, in particular with regard to the rim and the end separated from each other by the aforementioned distance. The tolerance range of this dimension is added to the dimension chains of the appliance.

### OBJECT OF THE INVENTION

The object of the invention consists of producing a starter that remedies the aforementioned drawbacks, so as to obtain precise centering and positioning of the ring gear of the gearbox, while simplifying the operations of machining support, and reducing the chains of dimensions of the starter.

The starter according to the invention is characterised in that the ring gear of the gearbox comprises a first abutment face situated in the same plane as the connection interface between the support and the housing. The connection interface is delimited between a second abutment face of the support in axial abutment against a third abutment face of the housing. Machining of the support is simplified, since only the second abutment face of the support has been machined.

According to a preferential embodiment, the ring gear comprises a collar equipped with a first abutment face coming into contact with the support. The collar projects from the skirt of the ring gear in order to provide the centering of the housing and ring gear on the support. The ring gear of the gearbox is locked in axial translation by the said collar, and by a stop protrusion on the housing.

By virtue of the invention good electrical continuity is obtained between the housing and the starter support.

Compared with the solutions described in the documents U.S. Pat. Nos. 4,649,285 and 5,718,147, the base plate is eliminated and the housing is simplified since, by virtue of the invention, it comes directly into abutment on the support without the presence of a rim.

Considering the document WO 01/31195, it can be seen that it is possible to simplify the starter further. This is because the ring gear of the gearbox in one embodiment advantageously comprises an extension conformed so as to provide a function of articulation of the control lever. In this way the use of an attached piece for producing the surface for the abutment and articulation of the control level is avoided and the machining operations are simplified in order to hold the parts to be assembled without clearance.

A stud made from flexible material, in particular elastomer, is preferably interposed between the extension of the ring gear and an abutment face of the contactor enclosure. The presence of the stud avoids the machining of this part of the contactor.

According to a first embodiment, the extension of the ring gear is provided with abutment means, such as one or two tongues, constituting a bearing at the rear part of the articulation of the lever, the front part of the said articulation being implemented by a housing on the starter support.

According to a second embodiment, the extension of the ring gear comprises a joint for articulation of the control lever, so as to completely integrate the pivot spindle of the lever in the ring gear of the gearbox. Various mountings are possible:
the joint and the control lever comprise orifices for inserting a through pivot spindle;
the joint is equipped with two elastic lugs provided with two aligned orifices for receiving the pivot spindle integrated in the lever;
the joint comprises two elastic lugs provided with swivels intended to engage in an annular groove in the control lever;
the joint comprises a U-shaped cradle serving as a housing for the pivot spindle, which can form part or not of the control lever.

According to a third embodiment, the extension for the articulation of the lever is formed by a piece fixed to the ring gear by fixing means known per se.

The extension can provide a supplementary function.

This is because, according to one embodiment, the ring gear of the gearbox comprises an extension conformed as a male stop element engaged in a cavity of the support receiving the control lever. The extension of the ring gear is adapted to the width of the cavity, which constitutes a female element for positioning and guiding the control lever.

The design of the starter support is simplified compared with that of the document FR2787833 since it does not require any ribs or specific shapes for the rotational stoppage of the ring gear. The cavity housing the control lever automatically fulfills this stop function when the ring gear extension is inserted.

Preferably, the ring gear extension comprises a joint for articulating the control lever or one or two tongues. The ring gear is also simplified, since the joint or the articulation tongue or tongues of the control lever simultaneously provide the rotational stoppage of the ring. A stud made from flexible material is in the aforementioned manner interposed between the ring gear extension and an abutment face of the contactor.

The risks of deformation of the thermoplastic ring gear during moulding are limited, and the absence of ribs and other shapes in relief inside the starter support releases available volume for housing more bulky components, for example a starter head with a larger diameter.

The extension can be moulded in one piece with the ring gear, or be formed by a piece secured to the ring gear by fixing means.

### SUMMARY DESCRIPTION OF THE DRAWINGS

Other advantages and characteristics will emerge more clearly from the following description of an embodiment of the invention given by way of non-limiting example, and shown in the accompanying drawings, in which:

FIG. 1 is a view in axial section of a starter equipped with an articulated starter head control lever according to the invention;

FIG. 2 shows a view in section to a larger scale of the ring gear of the gearbox, which comprises an articulation joint with attached pivot spindle;

FIG. 3 depicts a profile view of FIG. 2;

FIGS. 4, 5 and 7 are views identical to FIG. 3 of three variant embodiments of the articulation of the starter head control lever;

FIG. 6 is a view in vertical section of FIG. 7;

FIG. 8 is a view of the inside of the starter support at the toothed ring gear of the gearbox;

FIG. 9 is a view in section along the line 9-9 in FIG. 8;

FIG. 10 is a view in section to a larger scale of the gearbox of FIG. 1, showing the centering of the ring gear with respect to the support and the housing;

FIG. 11 is a partial view similar to FIG. 3 without the lever for another variant embodiment with a single extension tongue of the ring gear of the starter gearbox.

### DESCRIPTION OF A PREFERENTIAL EMBODIMENT OF THE INVENTION

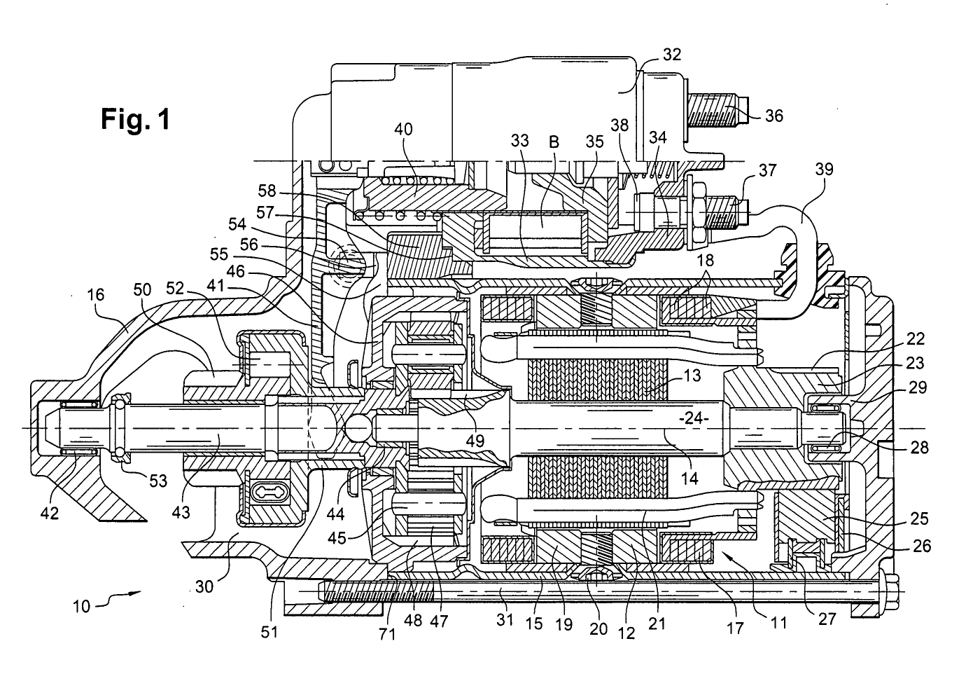

With reference to FIG. 1, the starter 10 comprises an electric motor 11 composed of a stator 12 and a rotor 13 mounted coaxially, the stator 12 surrounding the rotor 13, which is mounted so as to rotate about a spindle 14 inside a housing 13. The latter is fixed to the metal support 16 of the starter intended to be fixed to a fixed part of the motor vehicle.

The support 16 is here made from castable material, for example based on aluminium.

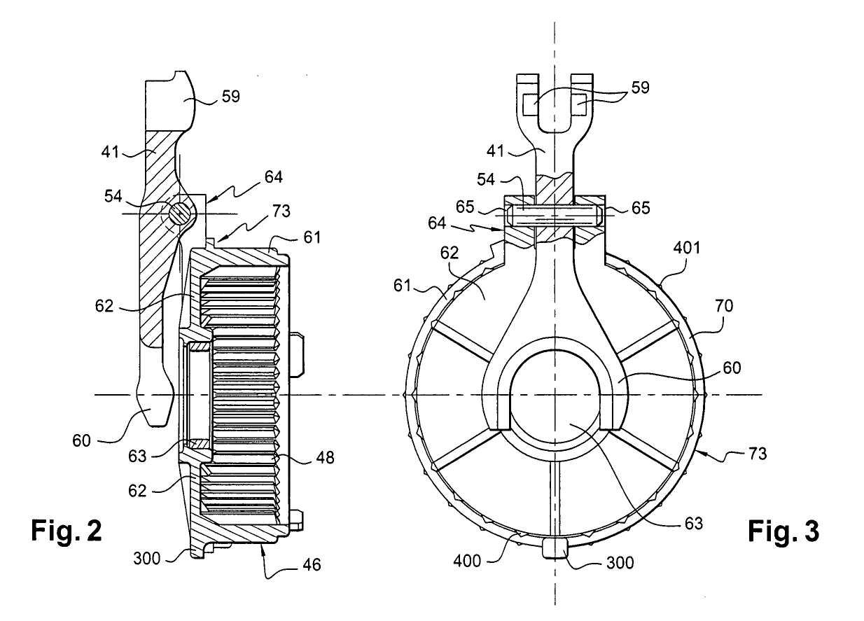

The stator 12 comprises for example an induction coil 17 comprising two pairs of windings 18, which are each wound around a pole shoe 19 fixed to the housing 15. The pole shoes 19 are fixed by means of screws 20 to the housing 15, here metallic, as described in the document FR-A-2 611 096 (FIG. 1). Each winding 18 is composed of a continuous conductor wound around the pole shoes 19 in the direction of its thickness so as to form concentric contiguous turns of increasing diameter, as can be seen more clearly in FIGS. 2 to 5 of the document EP A 749 194. The axis of each winding 18 is radial with respect to the axis 14 of the rotor 13 which constitutes the rotation axis of the electric motor 11.

The rotor 13 comprises a packet of metal sheets provided with grooves for mounting electrical conductors 21 in the shape of hairpins. These conductors 21 are connected together in order to form a rotor winding connected to conductive blades 22 belonging to a collector 23 fixed to the shaft 24 of the electric motor 11. In a variant, the winding is of the continuous wire type.

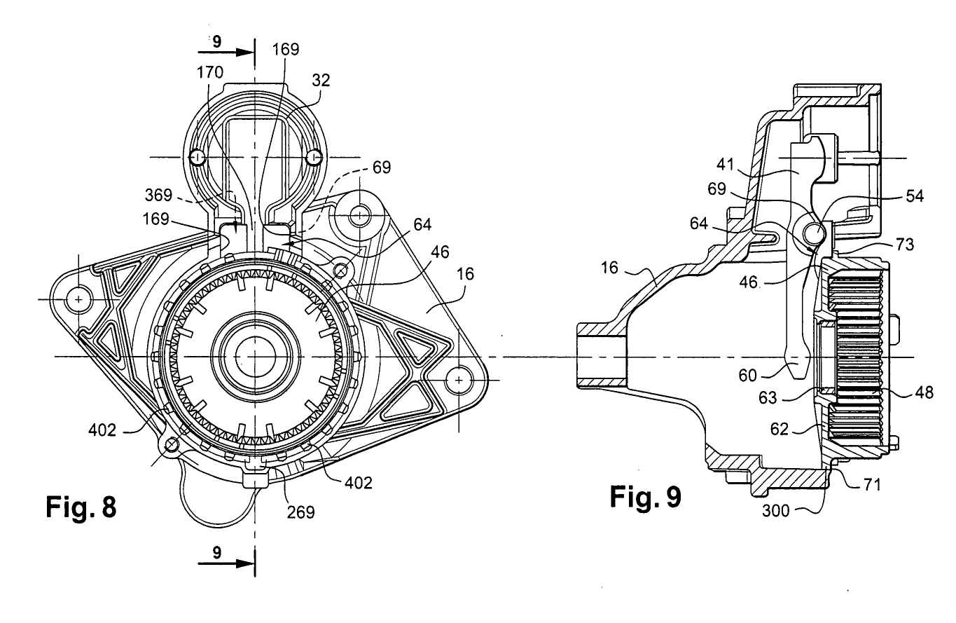

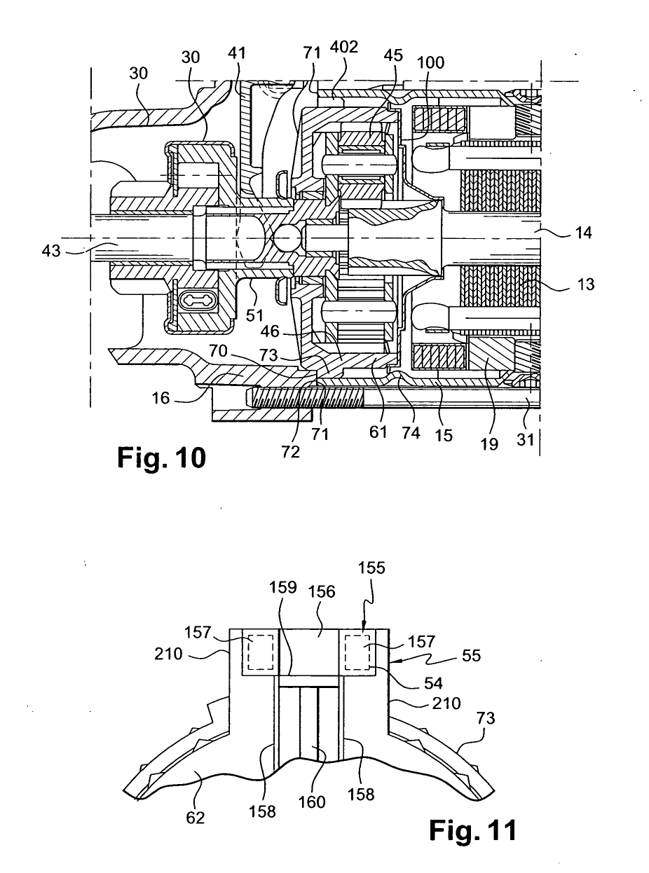

Brushes 25 rub on the collector blades 22 of the collector 23 in order to supply the rotor winding. The brushes 25 belong to a brush holder 26 equipped with guidance and reception cages for the brushes, which are biased in the direction of the collector blades 22 by springs 27. The brush holder 26 is fixed to a rear bearing 28 having in the central part a housing for mounting a needle bearing 29. The bearing 28 serves for the rotational mounting of the rear end of the shaft 24 of the electric motor. The axis of this shaft 24 is merged with the axis 14 of the rotor 13 and with the axis of the output shaft 43, constituting the shaft of the starter head 30. The rear bearing 29 serves as a centering device for the rear end of the housing 15 and is connected by tie rods 31 to the support 16 of the starter 10. In FIG. 8 two threaded holes (not referenced) can be seen in the support for screwing the tie rods. These holes are diametrically opposed and are each produced by means of a radially and axially projecting lug that the support has at the rear (see also FIGS. 1 and 10). The tie rods 31 are located outside the housing 15. Here a small clearance exists between the tie rods and the external periphery of the tubular-shaped housing 15.

It can be seen in FIG. 8 that the support has two large ribbed lugs, each lug comprising a hole for the passage of a member, such as a screw or bolt, for fixing the support to a fixed part, such as the crankcase of the internal combustion engine. One of the lugs has an additional hole. Here the holes are threaded.

The starter 10 also comprises an electromagnetic contactor 32 extending parallel to the electric motor 11 whilst being installed radially above it. The contactor 32 has an enclosure 33 carried by the support 16 and equipped with an excitation coil B provided with at least one winding. The enclosure 33 is closed at the front by a cover 34 made from electrically insulating material. The cover 34 is fixed by folding over the material of the free end of the enclosure 33. A shoulder on the enclosure 33 ensures the axial fixing of a fixed core 35, which is fixed axially in the other direction by the cover 34 carrying electrical supply terminals 36, 37.

The terminals 36, 37 are conformed so as each to form a fixed contact 38 inside the cover 34. One of the terminals 36 is intended to be connected to the positive terminal of the battery, the other 37 is connected by means of a cable 39 to the input of the induction winding 17 of the stator and to the positive-polarity brushes 25. When the coil B is energised, a moving core 30 is attracted by magnetic attraction in the direction of the fixed core 35 in order to cause simultaneously the closure of the contacts of the contactor 32 and the actuation of a lever 41 controlling the starter head 30.

The output shaft 43 is mounted in a front bearing 42 of the support 16, consisting by way of example of a needle bearing. The rear end of the output shaft 43 has, as described in the document FR-A-2787833, a recess for fitting a plain bearing 44 serving for the rotational mounting of the front end of the shaft 24 of the electric motor 11. This front end is configured so as to form a sun pinion 49 belonging to an epicyclic train constituting a gearbox 45, which is interposed between the output shaft 43 and the shaft 24 of the electric motor 11.

The gearbox 45 comprises a cylindrical ring gear 46 immobilised in rotation and having an annular skirt 61 toothed internally (FIGS. 1, 2, 6, 10). The skirt is axially oriented and therefore has a cylindrical shape. The teeth 48 on the skirt 61 of the ring gear 46 have an axial orientation and mesh with planet pinions 47 mounted for rotation about spindles carried by a transverse plate fixed to the rear end of the shaft 43 of the starter head 30. The ring gear 46 is a moulded piece. Here the ring gear 46 is made from mouldable plastics material, preferably rigid thermoplastic material, advantageously reinforced with fibres.

The starter head 30 is mounted so as to slide on the output shaft 43 and comprises a drive pinion 50, a driver 51 actuated by the pivoting control lever 41 and a freewheel 52 interposed axially between the driver 51 and the pinion 50.

The support 16, hollow in shape, comprises housings for the starter head 30 and for the lever 41, as can be seen more clearly in FIGS. 1 and 8 to 10.

The driver 51 is provided internally with helical flutes in engagement in a complementary manner with external helical teeth carried by the output shaft 43. The starter head 30 is thus driven in a helical movement when it is moved by the lever 41 against the stop 53 in order, through its pinion 50, to come into engagement with the starter ring of an internal combustion engine (not shown) by means of a scallop produced in the front part, in the shape of an ogive, of the hollow support 16 (FIGS. 1, 9 and 10).

It is clear that the freewheel device 52 can be replaced by a coupling device with conical meshing, of the type described in the document FR-A-2772433.

Likewise it is clear that the starter head 30, in a variant, is installed partly outside the support at the front thereof. More precisely, the pinion 50 of the starter head 30, instead of being installed in the support (FIGS. 1 and 10), can be installed outside the support, as can be seen for example in the document FR A 2 745 855, to which reference should be made.

The internal combustion engine can be fixed or belong to a motor vehicle, such as a private car or a boat.

The control lever 41 is coupled by its top end to the movable core 40 of the contact 32, and comprises in its middle part a pivot spindle 54, which, according to one characteristic, can be integrated partially or wholly in an extension of the fixed toothed ring gear 46 of the gearbox 45. The lever 41 is made from a moulded part, preferably from rigid thermoplastic material, preferably reinforced with fibres.

As can be seen more clearly in FIGS. 8 and 9, the support comprises a first housing for in particular the bottom part of the lever 41 and for the front part of the ring gear 46 and a second housing of smaller size for mounting the pivot spindle 54 and the top part of the lever. In FIG. 8 two holes can be seen at the second housing for fixing the enclosure of the contactor by means of screws. The contour of the second housing comprises an annular shoulder for abutment of the front part of the cylindrically-shaped enclosure 33.

The first housing can be delimited at the rear by an annular-shaped contour for housing the front part of the ring gear 46.

The contour of the second housing extends in axial projection with respect to the contour of the first housing (FIG. 9).

A radial passage 170 is produced between the two housings (FIG. 8).

This passage comprises a cavity 69 described below.

According to FIG. 1, the extension of the ring gear 46 of the gearbox 45 consists of one or two flat tongues 55 each comprising a semi-cylindrical bearing 56 intended to receive the pivot spindle 54.

The tongue or tongues 55 are located at the external periphery of the ring gear 46 and are here moulded in one piece with the ring gear 46. This tongue or tongues 55 are transversely oriented with respect to the axis 14 and are directed towards the electromagnetic contactor 32. This bearing or bearings 56 constitute abutment means for the lever 41 and the rear portion of the articulation, whilst the front part of the articulation is produced by the housing in a form of a bearing on the support 16. The space remaining between the rear of the tongue or tongues 55 and the abutment face 57 of the contactor 32 is occupied by an elastomer sealing stud 58 able to absorb the dimensional variations.

In this example embodiment, the semi-cylindrical bearing 56 is moulded with the extension tongues 55 of the ring gear 46, and the pivot spindle 54 is moulded with the control lever 41. The advantage of such an assembly avoids the use of an attached piece to produce the abutment and articulation surface for the lever 41 and simplifies the machining operations for holding the parts to be assembled without clearance.

FIGS. 2 to 7 show other example embodiments in which the pivot spindle 54 of the lever 41 is totally integrated in the ring 46 of the gearbox 45.

With reference to FIGS. 2 and 3, the control lever 41 comprises articulation housings 59 at the top part for connection with the movable core 40, and a fork 60 at the bottom part intended to engage in the driver 51. The axially oriented annular skirt 61 with internal teeth 48 of the ring gear 46 is connected to a radial flange 62, which has at its centre a hole 63 through which the output shaft 43 passes coaxially.

The flange 62, oriented transversely with respect to the axis 14, constitutes the bottom of the ring gear 46. This flange 62, belonging to the front part of the ring gear 46, comprises preferably dorsally radial ribs (not referenced in FIG. 3) for stiffening it.

The ring gear 46 of the gearbox 45 is provided with a joint 64 allowing insertion of the pivot spindle 54 for articulation of the lever 41. The joint 64 replaces the tongues 55 and is advantageously moulded with the ring gear 46, whilst the pivot spindle 54 is an attached piece passing through a hole in the lever 46 in order to be housed in aligned orifices 65 in the joint 64, which extends transversely to the external periphery of the ring gear 46, in the direction of the contactor in FIG. 1.

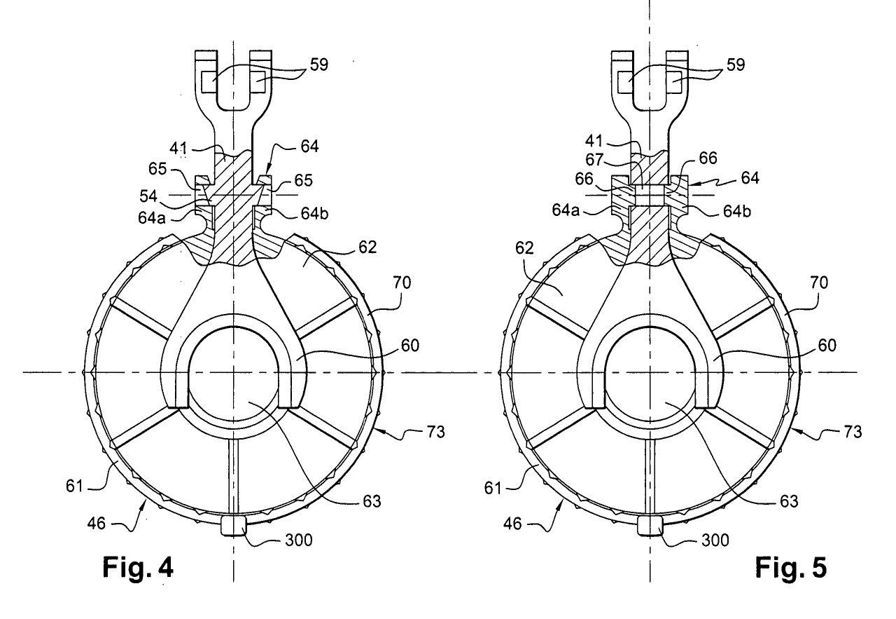

In FIG. 4, the joint 64 of the ring gear 46 is formed by two elastic lugs 64a, 64b provided with two aligned orifices 65. The pivot spindle 54 is moulded with the lever 41 and can be introduced into the orifices 65 after transverse separation of the lugs 64a, 64b.

In FIG. 5, the two elastic lugs 64a, 64b of the joint 64 are each provided with a swivel 56 snapping into an annular groove 67 in the control lever 41 in order to constitute the articulation of the latter on the ring gear 46.

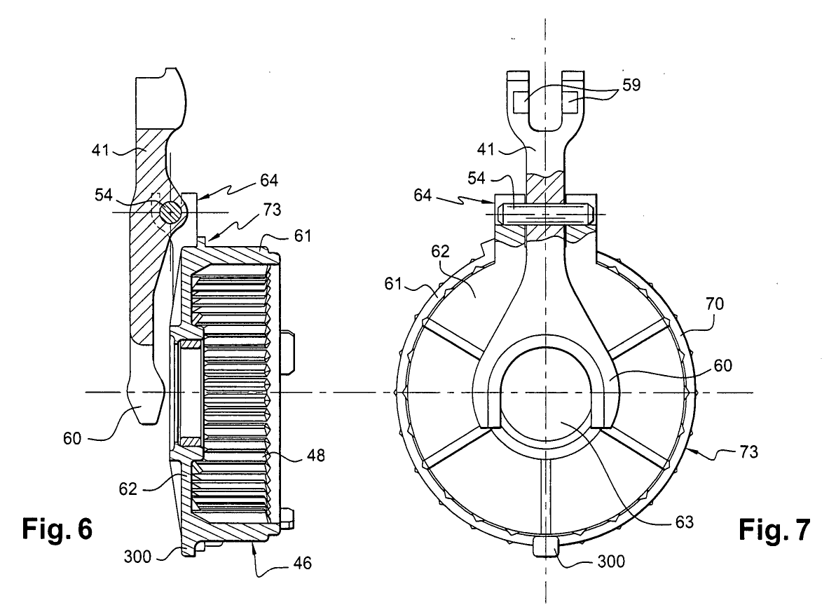

In the variant in FIGS. 6 and 7, the joint 64 provided on the extension of the toothed ring gear 46 comprises a U-shaped cradle 68 in which the pivot spindle 54 is engaged. The latter can be integrated in the control lever 41, in particular by moulding, or be attached transversely in an orifice of the lever 41.

It is clear that the joint 64 housing the pivot spindle 54 can consist of a piece fixed on the toothed ring gear 46, instead of being moulded directly with the ring gear of the gearbox, as in the examples in FIGS. 2 to 7. The articulation piece can be mechanically fixed to the ring gear by any fixing method, in particular by welding, adhesive bonding, snapping on, crimping, or sliding in a T-shaped groove or dovetail.

The integral mounting of the articulation of the control lever 41 of the ring gear 46 of the gearbox 45, as depicted in the example embodiments in FIGS. 2 to 7, obtains the following advantages:
simplification of the machining of the support 16,
the abutment face 57 of the contactor 32 and the housing of the abutment for the lever 41 can remain unmachined,
the elastomer sealing stud 58 is a less expensive part than the abutment for the lever according to the document FR-A-2787833.

With reference to FIGS. 8 and 9, the rotational locking of the toothed ring gear 46 is advantageously achieved by the joint 64, which is housed in a cavity 69 of complementary shape provided in the aforementioned manner in the support 16. In addition to its function of articulation of the control lever 41, the joint 64 simultaneously constitutes a male stop element that is sized so as to fit the width of the cavity 69. The latter, already arranged for the positioning and guidance of the control lever 41, constitutes a female element for holding the joint 64 for rotationally immobilising the ring gear 46 of the gearbox 45.

This cavity 69 is delimited on the one hand by a bottom in two parts, referenced in a broken line at 369 in FIG. 8, for abutment of the joint 64, and on the other hand by two lateral edges 169. The lateral edges are connected to transversely offset axial edges (not referenced). This is achieved by moulding.

In a variant the tongue or tongues (FIGS. 1 and 11) constitute the male stop element.

The extension of the ring gear, constituting a male stop engaged in a cavity 69 of the support 16 receiving the control lever, is therefore conformed so as to fulfill a rotational-stop function for the ring gear.

This extension is also conformed so as to fulfill a function of articulation of the control lever 41.

The stud 58 is interposed between an abutment face 57 of the enclosure 33 of the contactor 32 and the extension. This stud is configured at its internal periphery so as to cooperate with the external periphery of the housing 15, which thus has no scallop at this level and has a simple shape.

The starter support 16 is thus simplified compared with that of the documents FR-A-2787833 and FR-A-2767157, since it does not require any specific ribs or grooves for the rotational stoppage of the toothed ring gear 46. The absence of ribs or other protuberances in relief inside the support 16 of the starter releases available volume to house a more bulky component, for example a starter head 30 of greater diameter.

The joint 64 has in the example in FIGS. 8 and 9 a dual function of articulation of the lever 41 and rotational stoppage of the ring gear 46, which also simplifies the manufacture of the latter. The risks of deformation on moulding of the ring gear 46 from thermoplastic are thus limited.

FIG. 10 shows the device for positioning the ring gear 46 of the gearbox 45 with respect to the support 16 of the starter and the housing 15 of the electric motor 11. The ring gear 46 has at its projecting external periphery a collar 73 having a first abutment face 70 situated in the same plane as the second abutment face 71 of the starter support 16 and as the third abutment face 72 of the housing 15 of the field winding.

More precisely, the collar 73, here of radial orientation and annular in shape, is offset axially with respect to the bottom 62, as can be seen more clearly in FIGS. 2 and 6.

The second abutment face 71 of the support is formed at the free end of the support 16, here metallic, that is to say at the rear end of the support 16.

The third abutment face of the housing 15, here metallic, is formed by the free end of the housing 15 adjacent to the second abutment face 71.

The abutment faces 70 to 72 extend transversely with respect to the axis 14.

The centering of the toothed ring gear 46 in the support 16 is provided by the first abutment face 70 of the collar 73. The centering of the housing 15 on the ring gear 46 is effected on the outside diameter of the collar 73. The third abutment face 72 of the housing 15 is in contact with the second abutment face 71 of the support 16, which permanently guarantees the electrical continuity between the housing and the support.

It should be noted that the collar 73 is extended towards the rear, in the opposite direction to the lever 41, by a network of axially oriented ribs 402 of different lengths. These ribs, distributed circumferentially, reinforce the skirt 61. It can be seen in FIG. 2 that the external periphery of the front portion of the skirt 61, extending between the flange 62 and the abutment face 70 of the collar 73, has a pointed projection 400. Likewise, pointed projections can be seen at 401, which extend at the external periphery of the ribs 402, as can be seen more clearly in FIG. 8.

Thus the front portion is easily fitted by clamping in the first housing of the support and likewise the housing is forcibly mounted on the ribs 402. This is made easy by virtue of the projections 400, 401, which participate in the rotational locking of the ring gear and housing 15.

The locking in axial translation of the ring gear 46 of the gearbox 45 results from the presence of the radial collar 73 which, through its abutment face 70, bears against the second abutment face 71 of the support 16, and a stop protrusion 74. The latter is obtained by a shape pressed in the housing 15, and coming into abutment against the skirt 61 opposite to the collar 73.

More precisely, the protrusion comes into abutment on the skirt 61 by means of a radial rim on a metal piece 100 called a dust cover, axially fixed on the free end of the skirt by means of a shoulder (not referenced) thereon. The free end of the skirt 61 has axial lugs, here four lugs circumferentially distributed in a regular manner, each engaged in a scallop in the piece 100 for rotational fixing thereof.

The collar 73 for centering and positioning the ring gear 46 simplifies the machining operations and reduces the chains of dimensions of the starter. Only the second abutment face 71 of the support 16 must be machined.

As is clear from the description and drawings, the tongues 55 and lugs 64a, 64b of the joint 64 form between them a space for passage of the control level 41, here made from plastics material. The tongues 55 correspond to the lugs 64a, 64b of the joint 64 each ending with one bearing 56.

The lever 41 is connected to the movable core 40 via a rod elastically coupled to the movable core 40 as can be seen partially in FIG. 1, and more clearly visible in FIG. 2 of the document FR-A-2787833. The fork 60 has at its bottom end two fingers entering a groove formed in the driver 51, one of the flanks of the groove being formed by a washer mounted by snapping onto the driver, as described in the document FR-A-2687736.

The housing 15, cylindrical in shape like the enclosure 33, has a simplified structure by virtue of the invention since the ring gear 46 has an extension, having here roughly a transverse orientation. This extension extends substantially in line with the flange 62 of the ring gear 46, hollow in shape, serving as a housing for the epicyclic gear box.

Naturally the present invention is not limited to the example embodiments described. Thus, in a variant, the spindle 54 is moulded in one piece with the lever 14 and there is provided, in the aforementioned manner, as can be seen in FIG. 11, a single transversely oriented tongue 55 directed towards the contactor and having at its external periphery a hollow 155 for receiving the pivot spindle 54, cylindrical in shape. The tongue 155 therefore has a reduced thickness at its hollow 155, roughly rectangular in shape and emerging at the external periphery of the tongue 55, roughly rectangular in shape.

The bottom 159 of the hollow 155 constitutes a shoulder for the spindle 54 and advantageously has a rounded profile. p This spindle 54 is here of the type visible in FIG. 4 and therefore comprises two cylindrical studs or swivels extending on each side of the body of the lever 41.

For simplicity only the studs of the spindle 54 have been shown in FIG. 11 in broken lines.

In this case, these studs are each delimited by a planar face of transverse orientation, unlike the studs of the spindle 54 in FIG. 4, which are delimited by an inclined face for separation of the lugs in FIG. 4.

The width of the hollow 155, produced in the rear face of the tongue 55 turned towards the support 16, is greater than the length of the spindle 54.

The height of this hollow is greater than the diameter of the spindle 54.

In this FIG. 11, the hollow 55 has centrally a reduction in thickness 156, which thus delimits two surfaces 157 extending on each side of the reduction in thickness 156. These surfaces 157 are surfaces for the studs of the pivot spindle 54.

The reduction in thickness 156 avoids interferences with the body of the lever 41.

As is clear from the description and from FIG. 11 the rounded profile of the bottom 159 is sized according to the diameter of the studs of the spindle 54.

The advantage of such a mounting avoids the use of an attached piece for producing the abutment and articulation surface for the lever 41, and further simplifies the machining operations for holding without clearance the parts to be assembled since the hollow is easier to produce than the bearing or bearings 56. In addition a robust wide tongue 55 is obtained. The bottom 59 constitutes, in relation to the surfaces 157, a cradle for the spindle of the lever 41 and therefore an abutment surface for the latter.

The width of this tongue 55 is sized according to the cavity 69 in FIG. 81. The lateral edges 210 of the tongue 55 are adapted to cooperate in a complementary manner with the lateral edges 169 (FIG. 8) delimiting the cavity 69 for rotational locking or immobilisation of the ring gear 46.

Here the tongue 55 has been stiffened centrally.

Thus two ribs 158 are provided, extending on each side of a rib 160 of the type visible in FIG. 3.

For easy formation of these ribs for moulding with the ring gear, a central opening 210 is provided, centrally affecting the bottom 159 at the level of the reduction in thickness 156 of the hollow 155.

The ribs 158 delimit the lateral edges of the rectangular-shaped opening 210. The central rib 160 emerges in the longitudinal bottom of the opening 210.

It should be noted with reference to FIGS. 3, 4, 5, 7 that the toothed ring 46, or more precisely the flange 62, has a projecting toe referenced 300 in FIGS. 2 and 3. This toe extending diametrically opposite with respect to the joint 64, or in a variant with respect to the tongue or tongues 55 replacing the joint 64. This toe is received in a complementary manner in a cavity 269 in the support 16 and thus participates in the rotational locking of the ring gear 46 in association with the extension of the ring gear in the form of a joint 64 or at least one tongue 55.

1. Starter for an internal combustion engine comprising an electric motor (11) having a cylindrical housing (15) supporting the stator (12) and a rotor (13) coupled to an output shaft (43) for the rotational driving of a starter head (30) with the interposing of an epicyclic gearbox (45), the said gearbox comprising:
a ring gear (46) having an internally toothed cylindrical annular skirt (61), and a radial flange (62) provided with a hole (63) for coaxial passage of the output shaft (43),
and means of axial centering of the said ring gear (46) in the support (16) of the starter,
characterised in that the ring gear (46) of the gearbox (45) has a first abutment face (70) situated in the same plane as the connection interface between the support (16) and the housing (15).

2. Starter according to claim 1, characterised in that the connection interface is delimited between a second abutment face (71) of the support (16) in axial abutment against a third abutment face (72) of the housing (15).

3. Starter according to claim 2, characterised in that the ring gear (46) comprises a collar (73) equipped with the first abutment face (70) coming into contact with the support (16).

4. Starter according to claim 3, characterised in that the collar (73) projects from the skirt (61) of the ring gear (46) in order to provide the centering of the housing (15) and ring gear (46) on the support (16).

5. Starter according to claim 3, characterised in that the ring gear (46) of the gearbox (45) is locked in axial translation by the said collar (73) and by a stop protrusion (74) on the housing (15).

6. Starter according to claim 3, characterised in that the centering collar (73) is moulded directly with the ring gear (46).

7. Starter according to claim 1, characterised in that it comprises a starter head (30) provided with a driver (51), a control lever (41) in engagement with the driver (51) and a support (16) receiving a control lever (41), and in that the ring gear (46) of the gearbox (45) comprises an extension conformed so as to fulfill a function of articulation of the control lever.

8. Starter according to claim 1, characterised in that it comprises a starter head (30) provided with a driver (51), a control lever (41) in engagement with the driver (51) and a support (16) receiving a control lever (41), and in that the ring gear (46) of the gearbox (45) comprises an extension conformed as a male element engaged in a cavity (69) in the support (16) receiving a control lever (41).
